(19) United States
(12) Patent Application Publication
(10) Pub. No.: US 2017/0230284 A1
(43) Pub. Date: Aug. 10, 2017

(54) PACKET TRANSMISSION APPARATUS, CONTROLLER, AND PACKET TRANSMISSION CONTROL METHOD

(71) Applicant: FUJITSU LIMITED, Kawasaki-shi (JP)

(72) Inventors: Shinji Yamashita, Kawasaki (JP); Akiko Yamada, Kawasaki (JP)

(73) Assignee: FUJITSU LIMITED, Kawasaki-shi (JP)

(21) Appl. No.: 15/412,375

(22) Filed: Jan. 23, 2017

(30) Foreign Application Priority Data
Feb. 8, 2016 (JP) 2016-022048

(51) Int. Cl. H04L 12/741; H04L 12/721

(52) U.S. Cl. CPC H04L 45/74; H04L 45/38

(57) ABSTRACT

There is provided a packet transmission apparatus including: a memory in which identification information of a packet and information of a packet process for operating on the packet are stored in association, and identifiers of an input port to which the packet is input and an output port from which the packet is output are stored in association; and a processor coupled to the memory and the processor configured to: output the packet, when an identifier of the input port is stored in the memory, from the output port associating with the input port, and perform the packet process, when the identifier of the input port is not stored in the memory, based on the identification information and the information of the packet process stored in the memory.

### CROSS-REFERENCE TO RELATED APPLICATION

This application is based upon and claims the benefit of priority of the prior Japanese Patent Application No. 2016-022048, filed on Feb. 8, 2016, the entire contents of which are incorporated herein by reference.

### FIELD

The embodiments discussed herein are related to a packet transmission apparatus, a controller, and a packet transmission control method.

### BACKGROUND

The so-called Software defined networking (SDN) is a technique for controlling the behavior of the entirety of a network using software. An OpenFlow technique is one of the standards for implementing the SDN. An OpenFlow network includes an “OpenFlow switch” (OF-SW: which may be referred to as a “switch” hereinafter) with a data transmission function, and an “OpenFlow controller” (OFC: which may be referred to as a “controller” hereinafter) which is responsible for route control, both of which promote communication in accordance with an “OpenFlow protocol.”

The switch includes a flow table storing information for determining an operation (action) for packets input to the switch. In the OpenFlow, an aggregate of data identified by any combination of header information (Ethernet address, VLAN tag, IP address, TCP/UDP port number, etc.) of the packets is called a “flow.” The flow table is an aggregate of entries storing information related to the flow (hereinafter, referred to as a “flow entry”). The flow entry is constituted with a “match condition (also called a rule),” an “action,” and a “statistical information (statistics).”

The “match condition” is formed of parameters for specifying a packet, for example a packet identification information. The “action” is information indicating the processing contents (action) for a packet matching the “match condition.” The “statistics” indicates statistical information such as the number of packets that match the match condition and are subjected to a process based on an action. The switch may specify an entry including a match condition that a received packet matches, by referring to the flow table, and perform an action (e.g., outputting a packet from a port) defined by the specified entry.

The information related to the flow (flow entry) is generated by the controller and transmitted to the switch by using the “OpenFlow protocol.” The switch stores the flow entry received from the controller in the flow table. In this way, the controller unitarily manages the flow table of the switch under control of the controller itself.

Related technologies are disclosed in, for example, Japanese Laid-Open Patent Publication Nos. 2005-244400, 2006-19863, and 10-242977.

### SUMMARY

According to an aspect of the invention, a packet transmission apparatus includes: a memory in which identification information of a packet and information of a packet process for operating on the packet are stored in association, and identifiers of an input port to which the packet is input and an output port from which the packet is output are stored in association; and a processor coupled to the memory and the processor configured to: output the packet, when an identifier of the input port is stored in the memory, from the output port associating with the input port, and perform the packet process, when the identifier of the input port is not stored in the memory, based on the identification information and the information of the packet process stored in the memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary configuration of a network system according to an embodiment;

FIGS. 2A and 2B are views for explaining a method of setting an L path for broadband flow;

FIG. 3 illustrates an exemplary hardware configuration of an information processing apparatus (computer) which may be used as each of a controller and a switch;

FIG. 4 schematically illustrates the functions of the controller and the switch;

FIG. 5 is a view for explaining an L port DB;

FIG. 6 illustrates an example of a data structure of an L port table;

FIG. 7 is a flow chart illustrating an example of a process of an input/output processing part of the switch;

FIG. 8 is a flow chart illustrating an example of a process of the controller when an L path is set;

FIG. 9 is a flow chart illustrating an example of a process of the switch (OF-SW) that has received a FlowMod message;

FIG. 10 is a flow chart illustrating an example of a process of the switch (OF-SW) that has received an L port setting message;

FIGS. 11A and 11B are views for explaining Modification 1;

FIG. 12 illustrates an exemplary configuration of a controller and a switch according to Modification 2;

FIG. 13 is a flow chart illustrating an example of a process of the controller in Modification 2;

FIG. 14 is a flow chart illustrating an example of a process of the switch that has received a deletion instruction message;

FIG. 15 is a flow chart illustrating an example of Modification 2;

FIG. 16 illustrates an exemplary configuration of a controller and a switch according to Modification 3 of the embodiment;

FIG. 17 is a flow chart illustrating an example of a process of the controller in Modification 3; and

FIG. 18 is a flow chart illustrating an example of a process of the switch in Modification 3.

### DESCRIPTION OF EMBODIMENTS

With the recent advance of the SDN and Internet of Things (IoT), traffic patterns of a network have been diversified. For example, there exists a flow of a narrow band (fine granularity) such as the hypertext transfer protocol (HTTP) traffics or sensor data. Meanwhile, a flow requested for transmission in a broadband, such as bulk data transmission or streaming data transmission related to an inter- or intra-data center (DC) backup is increasing.

As an example of techniques for efficiently accommodating the flow requested for transmission in a broadband in a network, there is a technique in which an optical transmission apparatus performs an optical cut-through operation in a multilayer network including a packet network and an optical core network. However, the optical transmission apparatus is expensive. For this reason, it is required to use a packet transmission apparatus which is less expensive than the optical transmission apparatus to transmit the flow requested for transmission in a broadband.

However, when OF-SW is used as the packet transmission apparatus, there have been the following problems. The OF-SW determines an output port of a packet by referring to (looking up) a flow table for each packet, that is, searching a flow entry including the match condition matching the packet. In the flow requested for transmission in a broadband, since a large amount of data is transmitted, a reference to the flow table for a large amount of packets occurs.

However, although the search time of the flow table does not contribute to packet transmission, when the reference to the flow table frequently occurs, there is a possibility that the packet transmission time increases. In particular, when significant number of flow entries are registered with the flow table, it may take a long time to detect a flow entry matching a packet. In this case, the packet transmission time may further increase.

Hereinafter, embodiments of a packet transmission apparatus capable of reducing a time taken to transmit a packet, a controller thereof, and a packet transmission control method will be described with reference to the drawings. The configuration of the embodiments is just illustrative, and the present disclosure is not limited to the configuration of the embodiments.

Network Configuration

In an embodiment, an OpenFlow network system will be described as an example of an SDN network system. However, the configuration of the embodiment may be applied to SDN networks other than OpenFlow.

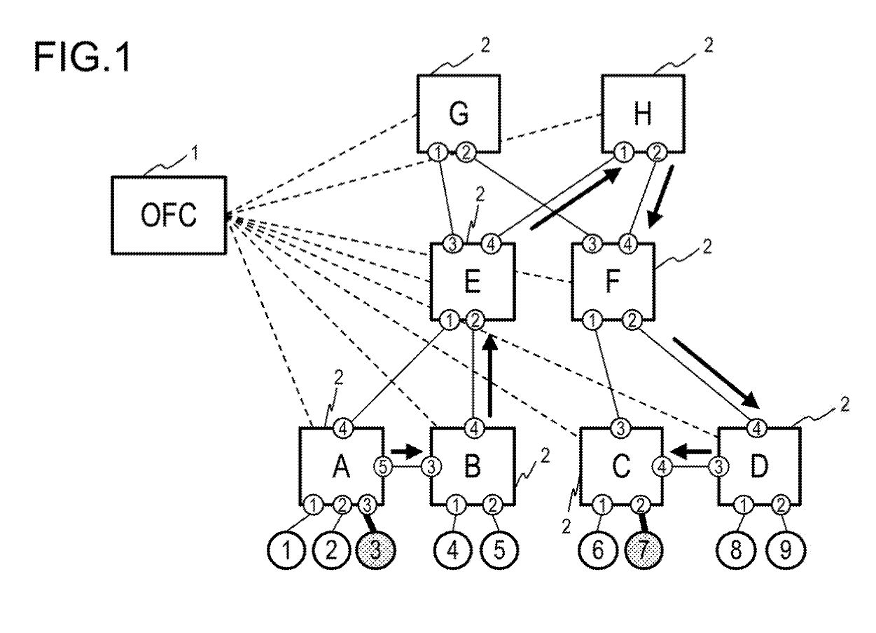

FIG. 1 is a view illustrating an exemplary configuration of a network system according to an embodiment. In FIG. 1, the network system includes a controller (OFC) 1 and a plurality of switches (OF-SW) 2 which are connected to and controlled by the controller 1. In FIG. 1, communication lines between the controller 1 and the switches 2 are indicated by dashed lines. The controller 1 is an example of a “controller of a packet transmission apparatus,” and the plurality of switches 2 are an example of a “plurality of packet transmission apparatuses.”

In the example illustrated in FIG. 1, switches A to H are represented as examples of the plurality of switches 2. The switches 2 have a plurality of ports used for packet transmission or reception. The plurality of ports are an example of a “plurality of input ports” and a “plurality of output ports.” In the example of FIG. 1, the switch A has five ports (ports 1 to 5), each of the switches B to F has four ports (ports 1 to 4), and each of the switches G and H has two ports (ports 1 and 2). However, the number of ports of the switches 2 may be appropriately set.

A host 1, a host 2, and a host 3 are connected to the port 1, the port 2, and the port 3 of the switch A, respectively. The port 4 of the switch A is connected to the port 1 of the switch E. The port 5 of the switch A is connected to the port 3 of the switch B. The port 1 of the switch B is connected to the host 4. The port 2 of the switch B is connected to the host 5. The port 4 of the switch B is connected to the port 2 of the switch E.

The ports of a switch 2 are connected to other switches 2 or the hosts as follows. Each of the hosts is a terminal which transmits/receives a packet. Nine hosts 1 to 9 are illustrated in the example of FIG. 1.

The port 1 of the switch C is connected to the host 6. The port 2 of the switch C is connected to the host 7. The port 3 of the switch C is connected to the port 1 of the switch F. The port 4 of the switch C is connected to the port 3 of the switch D. The port 1 of the switch D is connected to the host 8. The port 2 of the switch D is connected to the host 9. The port 4 of the switch D is connected to the port 2 of the switch F.

The port 3 of the switch E is connected to the port 1 of the switch G. The port 4 of the switch E is connected to the port 1 of the switch H. The port 3 of the switch F is connected to the port 2 of the switch G. The port 4 of the switch F is connected to the port 2 of the switch H.

The OFC 1 may set paths of the switches 2 for transmitting packets between hosts for the network formed by the plurality of switches 2 (the switches A to H). Each of the switches 2 (the switches A to H) includes a flow table with which a flow entry is registered. The flow entry includes a “match condition” which is packet identification information, and an “action” which defines an operation (action) for a packet matching the matching condition. The match condition is an example of “packet identification information,” and the action is an example of “action information.”

As for the parameters (values) that can be used as the packet identification information, for example, the following parameters may be used. One parameter or a combination of two or more parameters of a plurality of parameters described below is applied as the “match condition.” •“Switch Port (Ingress Port): reception (input) port,” •“MAC src: transmission source MAC (Media Access Control) address,” •“MAC dst: reception destination MAC address,” •“Eth type: protocol type,” •“VLAN-ID,” •“VLAN Priority: VLAN PCP (Priority Code Point) value,” •“IP src: transmission IP address,” •“IP dst: reception destination IP address,” •“IP Protocol number: protocol number,” •“IP ToS bits: ToS (Type of service) value,” •“Transport src port: transmission source port number,” and •“Transport dst port: reception destination port number.” In this way, the parameters include information (address information, an identifier of a virtual LAN, a protocol type, and so on) contained in a packet. In addition, the parameters may include information that is not contained in a packet such as a packet input port.

In addition, the “action” includes the definitions of the following actions. •“ALL: transmission to other all ports,” •“CONTROLLER: transmission to controller,” •“LOCAL: transmission to one specific port,” •“TABLE: execution of action of flow table,” and •“IN_PORT: transmission to input port (output from input port).”

In the “action,” a plurality of actions may be defined. In addition, when there is no definition of “action,” “Drop: discard of packet” may be performed. The flow entry may include statistics information. As the statistics information, the number of packets or the amount of packets matching any match condition is counted. This statistics information may be used as a condition for executing an action. In addition, the statistic information is transmitted to the controller 1 and used for control of the switches 2 by the controller 1. The “action” is an example of a “packet processing for a packet.”

The controller 1 generates a flow entry for a switch 2 and sends the flow entry to the switch 2. The switch 2 registers the flow entry provided from the controller 1 with the flow table. Upon receiving a packet, the switch 2 specifies a flow entry including the “match condition” matching the received packet by referring to the flow table, and performs an action defined by the “action” in the specified flow entry. For example, when the “action” indicates a packet output from any port, the packet is transmitted from the port.

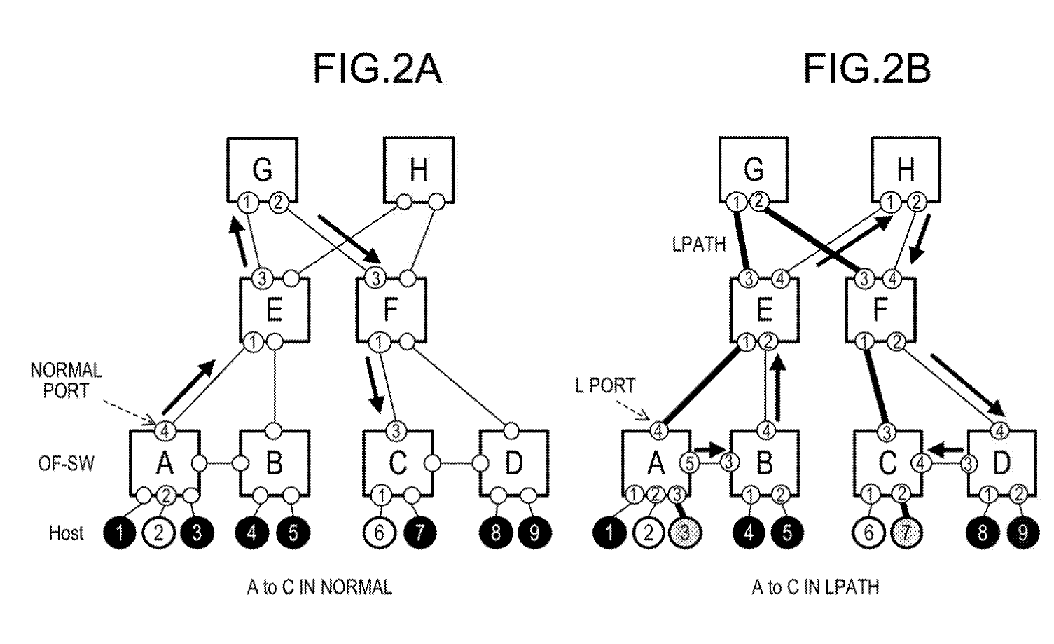

In FIG. 2A illustrates an example of path setting. In order to transmit a packet from the host 2 to the host 6, it is assumed that a path of switch A-switch E-switch G-switch F-switch C is set.

The controller 1 creates a flow entry for the switch A, the switch E, the switch G, the switch F, and the switch C in order to transmit the packet from the host 2 to the host 6 along the path. The flow entry is transmitted from the controller 1 to the switch A, the switch E, the switch G, the switch F, and the switch C.

Each of the switch A, the switch E, the switch G, the switch F, and the switch C registers the flow entry received from the controller 1 with the flow table. For example, as a match condition of the flow entry registered in the switch A, the switch E, the switch G, and the switch F, the common “match condition” for detecting the packet transmitted from the host 2 is defined. However, other match conditions may be defined as long as the packet from the host 2 may be detected in the switch 2.

In the meantime, as an action, for example, a packet output from the port 4 of the switch A is defined in the flow entry of the switch A. As an action, a packet output from the port 3 of the switch E is defined in the flow entry of the switch E. As an action, a packet output from the port 2 of the switch G is defined in the flow entry of the switch G. As an action, a packet output from the port 1 of the switch F is defined in the flow entry of the switch F. As an action, a packet output from the port 1 of the switch C is defined in the flow entry of the switch C.

Thus, the packet transmitted from the host 2 is received in the host 6 through the switch A, the switch E, the switch G, the switch F, and the switch C. In addition, when a packet is transmitted from the host 6 to the host 2 through the route, a flow entry for transmitting the packet from the host 6 to the host 2 is also registered in the switch A, the switch E, the switch G, the switch F, and the switch C.

In the embodiment, a flow requested for packet transmission in a broadband (a broadband flow) is treated as an “object flow.” The broadband flow is a flow of data desirable or requested for transmission in broadband networks or environments, such as bulk data or streaming data in a data center. In other words, the broadband flow is a flow requested for packet transmission by a communication speed higher than a communication speed of a flow other than the broadband flow (which is called a normal flow). The object flow (broadband flow) is an example of a “second flow,” and a flow (normal flow) other than the object flow is an example of a “first flow.”

In the embodiment, when the object flow is requested for transmission in the broadband, a path for transmitting a packet of the object flow at a communication speed higher than a communication speed for a flow other than the object flow is set. The set path is called a Limited Path (L path). The object flow may be a flow which is newly generated, or may be an existing flow. That is, the transmission request in the broadband includes a case where it is generated in accordance with the generation of the new flow and a case where it is generated in accordance with the existing flow. In addition, the L path may be set for all of the switches 2 on a route of the object flow or may be set for at least one of the plurality of switches 2.

For example, as illustrated in FIG. 2B, it may be assumed that a flow from the host 3 to the host 7 is newly generated, and a packet transmission request in the broadband with this flow as the object flow is generated. In this case, for example, the following L path is set over the entire route of the object flow.

L path from the host 3 to the host 7:

Host 3→port 3 of switch A→port 4 of switch A→port 1 of switch E→port 3 of switch E→port 1 of switch G→port 2 of switch G→port 3 of switch F→port 1 of switch F→port 3 of switch C→port 2 of switch C→host 7

In setting the L path, the controller 1 allocates an input port and an output port of the object flow to the switch 2 on the route of the object flow. At this time, for the switch 2 on the route of the L path, the input port and the output port allocated to the object flow are set for the exclusive use of the object flow. In other words, the controller 1 does not allocate input/output ports, which are allocated to the object flow, to flows (normal flows) other than the object flow in the switch on the L path. In this way, a port through which the L path passes (a port exclusively used by the object flow, which is called an L port) is not used for transmission/reception of the normal flows. When the input/output ports of the L path are exclusively used by the object flow, a band allocated to the object flow is secured.

In the embodiment, a case where input/output ports are exclusively used by the object flow will be described. However, there may be a case where the exclusive use of the input/output ports is not required. For example, when a band desired for the object flow is secured, there may be a case where the object flow shares at least one of the input port and the output port with flows other than the object flow.

In the example of FIG. 2B, the port 3 and the port 4 of the switch A are used as an input port and an output port of the L path, respectively. This is similarly applied to the port 1 and the port 3 of the switch E, the port 1 and the port 2 of the switch G, the port 3 and the port 1 of the switch F, and the port 3 and the port 2 of the switch C.

In the embodiment, when the L path is set, the state of exclusively use of the input/output ports is secured. When there is a normal flow passing through the L port, the route of the normal path is changed to pass through ports other than the L path. That is, the normal path retreats to a route other than the route of the L path. In the example of FIG. 2B, the route from the host 2 to the host 6 is changed so as not to pass through the L path as follows.

Normal path (retreat route) from the host 2 to the host 6

Host 2→port 2 of switch A→port 5 of switch A→port 3 of switch B→port 4 of switch B→port 2 of switch E→port 4 of switch E→port 1 of switch H→port 2 of switch H→port 4 of switch F→port 2 of switch F→port 4 of switch D→port 3 of switch D→port 4 of switch C→port 1 of switch C→host 6

In the switch 2, an entry indicating the input port and the output port exclusively used by the object flow is registered with a table (called an L port table) different from the flow table. A packet received in the input port registered with the L port table is output from the output port associated with the input port without referring to the flow table. Such avoidance of reference to the flow table is called a “cut-through.” The L port table is an example of a second table referred to in preference to the flow table (one example of a first table) in determining an output port of a packet. An output port related to a packet of a flow (normal flow) other than the object flow is determined by referring to the flow table.

Due to the avoidance of reference to the flow table, the packet transmission time of the object flow in the switch 2 may be reduced. That is, the communication speed for the object flow may be increased, as compared to the normal flow referring to the flow table. Further, due to the exclusive use of the input/output ports to exclude other flows, a throughput (transmission quantity) of the object flow may be increased. Thus, packets of a broadband flow may be effectively transmitted using the switch (OF-SW) 2. In other words, it is possible to accommodate a flow of data having a smaller granularity and a flow of data having a larger granularity with the OF-SW. Hereinafter, the embodiment will be described in detail.

Information Processing Unit

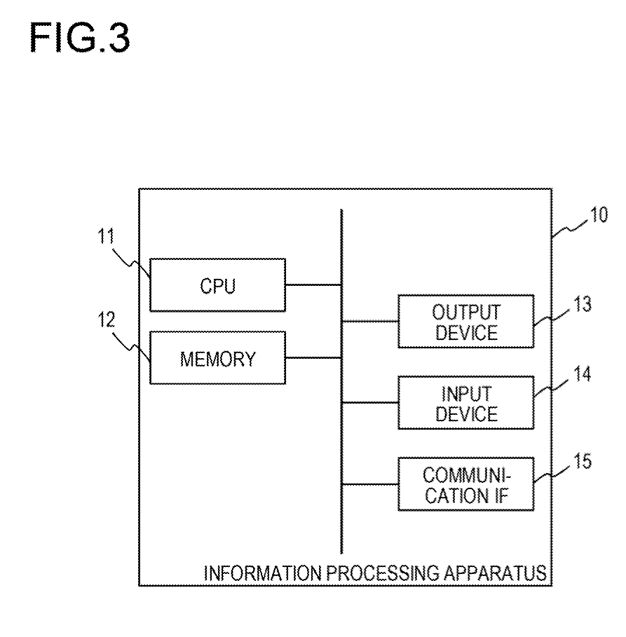

FIG. 3 illustrates an exemplary hardware configuration of an information processing apparatus (computer) 10 which may be used as each of the controller 1 and the switch 2. An example of the information processing apparatus 10 may include a general-purpose computer such as a personal computer (PC) or a work station (WS). Alternatively, a special-purpose computer such as a server machine may be applied. However, computers other than the above-mentioned PC, WS, and server machine may be used.

As illustrated in FIG. 3, the information processing apparatus 10 includes, for example, a central processing unit (CPU) 11, a memory 12, an output device 13, an input device 14, and a communication interface (communication IF) 15 which are interconnected via a bus. The CPU 11 is an example of a “control part” or a “controller,” and the memory 12 is an example of a “storage device,” a “storage part,” or a “storage medium.”

The memory 12 includes a main storage device and an auxiliary storage device. The main storage device is used as a deployment area of a program, a work area of the CPU 11, or a storage area or buffer area of data and programs. The main storage device is formed by a random access memory (RAM) or a combination of a RAM and a read only memory (ROM).

The auxiliary storage device is formed by, for example, a nonvolatile storage medium such as a hard disk drive (HDD), a solid state drive (SSD), a flash memory, or an electrically erasable programmable read only memory (EEPROM). The auxiliary storage device is used as a storage area of data and programs.

The output device 13 outputs data or information. The output device 12 is, for example, a display or a printer. The input device 14 is used to input information or data. The input device 14 is, for example, a key, a button, a pointing device such as a mouse, or a touch panel.

The communication IF 15 is an interface circuit which is connected to a network to transmit/receive data with other communication devices. The communication IF 15 is, for example, a communication interface card which is called a local area network (LAN) card or a network interface card (NIC).

The CPU 11 is an example of a processor and loads and executes a program stored in at least one of the main storage device and the auxiliary storage device in the memory 12. Thus, the CPU 11 operates the information processing apparatus 10 as the controller 1 or the switch 2.

The CPU 11 is also called a microprocessor (MPU). The CPU 11 is not limited to a signal processor but may be a multiprocessor. In addition, a single CPU connected by a single socket may have a multicore configuration. At least a portion of a process performed by the CPU 11 may be performed by a dedicated processor such as a digital signal processor (DSP), a graphics processing unit (GPU), a numerical data processor, a vector processor, or an image processor. In addition, at least a portion of a process executed by the CPU 11 may be executed by an integrated circuit (IC) or other digital circuit. In addition, the integrated circuit or the digital circuit may include an analog circuit. The integrated circuit includes an LSI, an application specific integrated circuit (ASIC) or a programmable logic device (PLD). The PLD includes, for example, a field programmable gate array (FPGA). At least a portion of a process executed by the CPU 11 may be executed by a combination of a processor and an integrated circuit. The combination is called, for example, a microcontroller (MCU), a system-on-a-chip), a system LSI, or a chip set.

Configuration of Controller and Switch

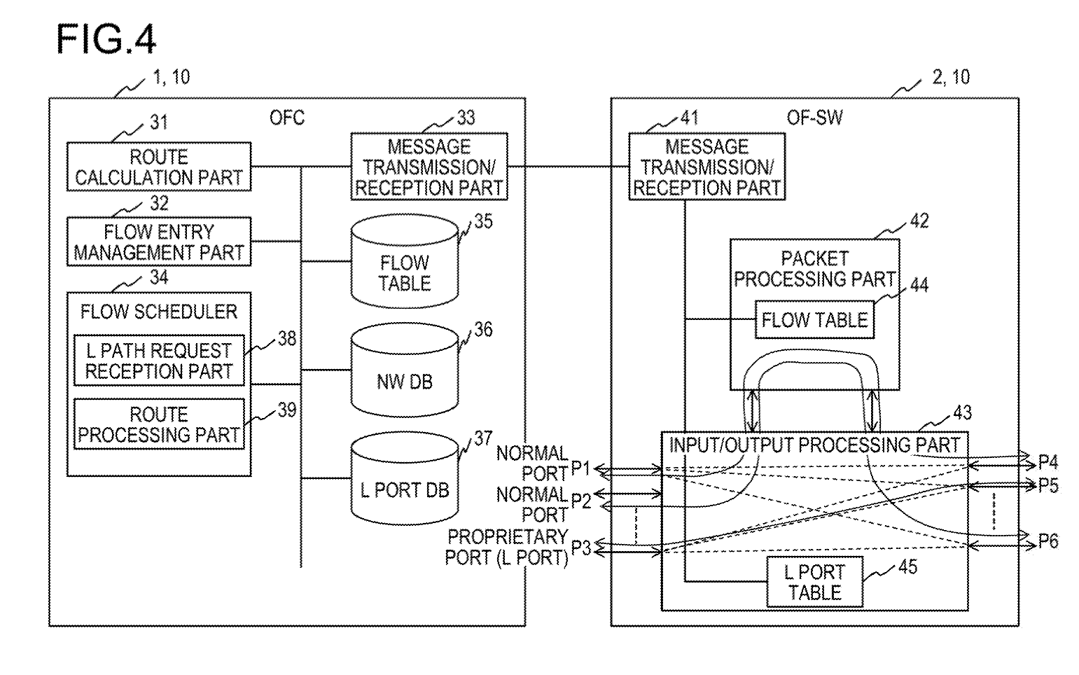

FIG. 4 is a schematic view illustrating functions of the controller (OFC) 1 and the switch (OF-SW) 2. The information processing apparatus 10 illustrated in FIG. 3 may operate as an apparatus (the controller 1) including the elements illustrated in FIG. 4 by the CPU 11 executing a program for the controller 1. In addition, the information processing apparatus 10 may operate as an apparatus (the switch 2) including the elements illustrated in FIG. 4 by the CPU 11 executing a program for the switch 2.

In FIG. 4, the controller 1 includes a route calculation part 31, a flow entry management part 32, a message transmission/reception part 33, and a flow scheduler 34. In addition, the controller 1 includes a flow table 35, a network database (NW DB) 36, and an L port DB 37. The flow scheduler 34 includes a reception part of an L path request (L PATH request reception part) 38 and a route processing part 39.

In this embodiment, the CPU 11 of the information processing apparatus 10 operates as the route calculation part 31, the flow entry management part 32, the message transmission/reception part 33, and the flow scheduler 34 by execution of a program. The flow table 35, the NW DB 36, and the L port DB 37 are created on the memory 12.

The NW DB 36 stores information related to a network configuration. For example, the NW DB 36 stores information of the switch 2 (the switches A to H) forming a network, information of a plurality of ports of the switches 2, and information indicating a route of a normal path (a port in use) set in the network.

In addition, the NW DB 36 may also store the amount or number of packets per unit time which are transmitted to or received from a port. The amount or number of packets may be used as information indicating a load of the switch 2. However, information other than the amount or number of packets may be used as the information indicating a load of the switch 2. In addition, the NW DB 36 may beforehand store information of a retreat route of the normal path when the L path is set.

The route calculation part 31 calculates a route among hosts by using, for example, specified information of a host transmitting/receiving a packet input using the input device 14 and configuration information of a network stored in the NW DB 36. For example, when the host 3 and the host 6 are designated, the route calculation part 31 calculates a route of the normal path, as described above with reference to FIGS. 2A and 2B.

The flow entry management part 32 generates a flow entry for transmission of a packet to the route calculated by the route calculation part 31. At this time, the flow entry management part 32 creates flow entries for switches 2 on the route. The created flow entries are stored and unitarily managed in the flow table 35. In addition, the created flow entries are included in a predetermined OpenFlow message (OF message) and transmitted from the message transmission/reception part 33 to the corresponding switch 2. The message transmission/reception part 33 transmits/receives the OF message with the switch 2 according to an OpenFlow protocol.

The flow scheduler 34 includes an L path request reception part 38 and a route processing part 39. The L path request reception part 38 receives a request to set an L path (L path setting request). When a user requests a broadband traffic newly or an existing traffic has a broadband in the middle, the reception part 38 receives the L path request. The L path request is input from, for example, the input device 14. Alternatively, the L path request may be received from a different communication device. The message transmission/reception part 33 is an example of a “transmission part,” and the flow scheduler 34 is an example of a “control part.”

The route processing part 39 uses the information stored in the NW DB 36 and the L port DB 37 to calculate a route of the L path, calculate an alternate route of a normal path to retreat according to a setting of the L path, generate a flow entry for a switch 2 based on results of the calculations, etc.

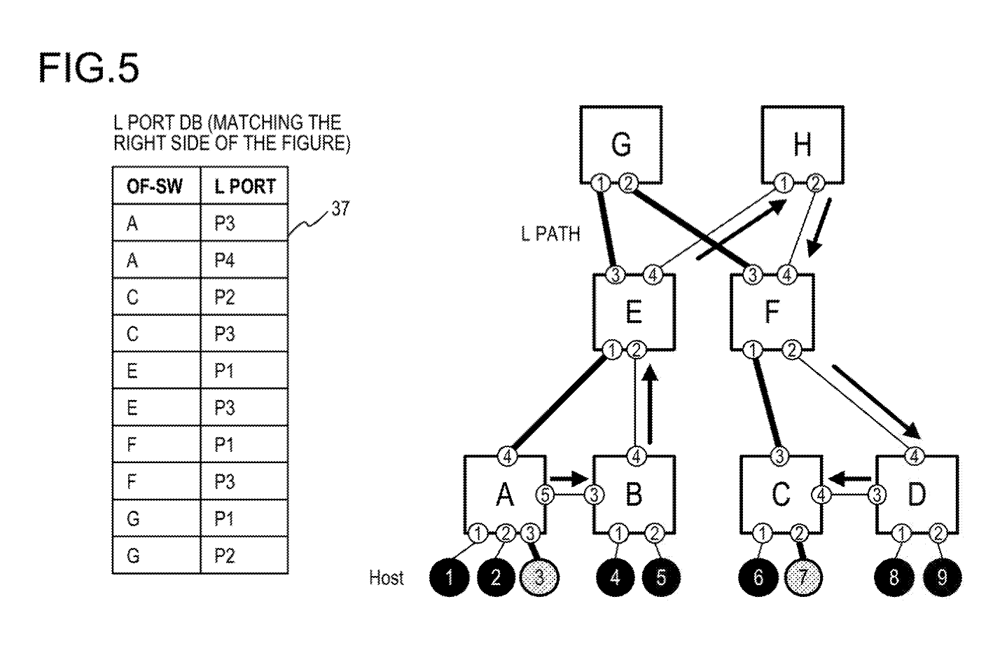

FIG. 5 is a view for explaining the L port DB 37. The L port DB 37 stores information indicating a correspondence relationship between the switch (OF-SW) 2 on the L path and an L port of the switch 2. For example, when the L path of the route described with reference to FIGS. 2A and 2B from the host 3 to the host 7 is set, contents registered with the L port DB 37 are as illustrated in FIG. 5.

Referring back to FIG. 4, the switch (OF-SW) 2 includes a message transmission/reception part 41, a packet processing part 42, and an input/output processing part 43. The packet processing part 42 includes a flow table 44, and the input/output processing part 43 includes an L port table 45.

In this embodiment, an example where the CPU 11 operates as the message transmission/reception part 41, the packet processing part 42, and the input/output processing part 43 will be described. However, at least a portion of processes performed by the message transmission/reception part 41, the packet processing part 42, and the input/output processing part 43 may be performed by a processor, an integrated circuit or a digital circuit other than the CPU 11. For example, a process of the input/output processing part 43 may be performed by a dedicated processor such as an integrated circuit or a network processor (NWP), and a process of the packet processing part 42 may be performed by the CPU 11.

The flow table 44 includes one or more flow entries. A flow entry supplied from the controller 1 is registered with the flow table 44. Addition, change, and deletion of a flow entry are controlled by the controller 1. The flow table 44 is an example of a “first table in which a packet identification information is stored in association with packet processing for the packet.” The flow entry is an example of a “first entry.” The input/output processing part 43 is an example of a “control part,” and the packet processing part 42 is an example of a “processing part.”

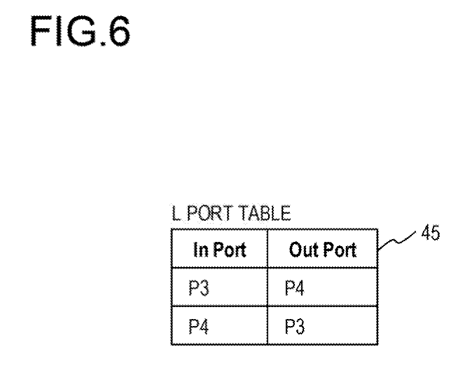

FIG. 6 illustrates an example of a data structure of the L port table 45. The entries including information indicating a correspondence relationship between an input port and an output port allocated to an object flow (identifiers of the input port and the output port) are registered with the L port table 45.

FIG. 6 illustrates an example of information registered with the L port table 45 of the switch A when the L path illustrated in FIG. 5 is set. FIG. 6 illustrates that the port 3 (P3) and the port 4 (P4) of the switch A are allocated as an input port and an output port of the L path between the host 3 and the host 7. In addition, FIG. 6 illustrates an example of registration where a bidirectional L path is set between the host 3 and the host 7. In this example of registration, a forward (host 3→host 7 (P3→P4)) entry and a backward (host 7→host 3 (P4→P3)) entry are registered.

In addition, an identifier (port number) of a port registered with the L port table 45 may be an identifier of a logical port which is a logical aggregation of a plurality of physical ports. This is because the plurality of physical ports may be used as one line, and a packet of one flow may be transmitted using a plurality of ports. The L port table 45 is an example of a “second table in which identifiers of an input port and an output port are stored in association,” and an entry registered with the L port table 45 is an example of a “second entry.”

The message transmission/reception part 41 transmits/receives an OF message with the controller (OFC) 1 according to a protocol of Open Flow.

The packet processing part 42 receives a packet from the input/output processing part 43 and searches a flow entry including a match condition for matching the packet by referring to the flow table 44. Upon detecting (hitting) a corresponding flow entry, the packet processing part 42 performs an operation (action) according to “action” in the detected flow entry.

The action includes a definition of “output a packet from a designated port (one specified port).” The packet processing part 42 sends the packet, along with information of a port designated in the action, to the input/output processing part 43. In this manner, the packet processing part 42 determines a port to output the packet by referring to the flow table 44.

The input/output processing part 43 has a plurality of ports. The plurality of ports is an example of a “plurality of input ports” and a “plurality of output ports.” The input/output processing part 43 performs connection (including a return point) between plural ports of the switch 2, connects a packet input from each port to a port of an output destination, and outputs the packet from the port of the output destination.

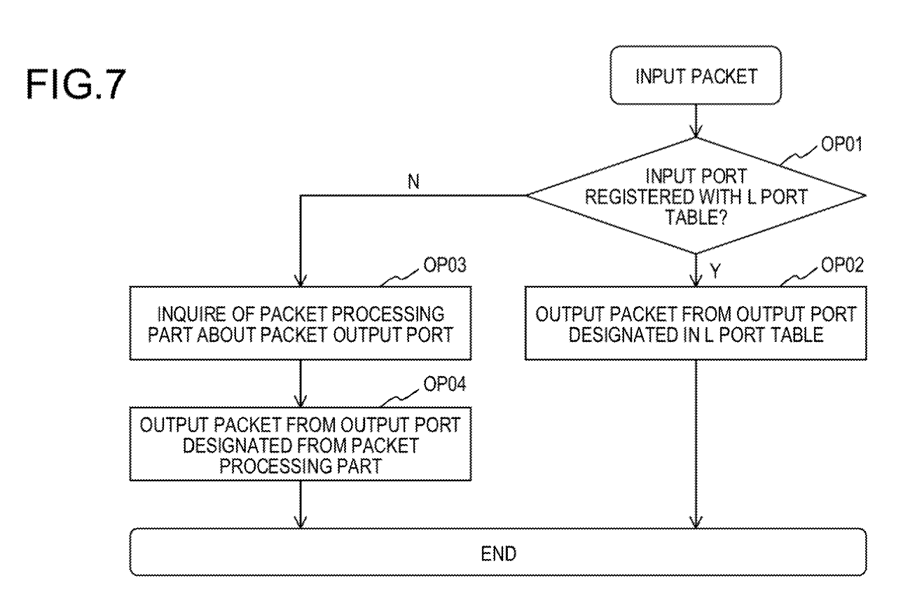

FIG. 7 is a flow chart illustrating an example of the process of the input/output processing part 43. The processing part of FIG. 7 starts in response to input of a packet from each port. At OP01, the input/output processing part 43 determines whether or not an input port of the packet (an entry matching the input port) has been registered with the L port table 45. When it is determined that the input port has been registered with the L port table 45, the process proceeds to OP01. Otherwise, the process proceeds to OP03.

At OP02, the input/output processing part 43 outputs the packet from an output port designated in the L port table 45. That is, the input/output processing part 43 connects the packet to an output port included in the entry matching the input port and outputs the packet from the output port.

At OP03, the input/output processing part 43 inquires of the packet processing part 42 about the output port of the packet. For example, the input/output processing part 43 transmits the packet to the packet processing part 42. Accordingly, the packet processing part 42 determines the output port of the packet by referring to the flow table 44. The packet and information indicating the determined output port are passed to the input/output processing part 43.

The above process may be modified as follows. For example, with the packet held in the input/output processing part 43, the input/output processing part 43 sends information, which is to be collated with a match condition of the packet, to the packet processing part 42, and receives a result of the determination of the output port (a designation of the output port) from the packet processing part 42. In this case as well, the input/output processing part 43 may acquire designation information of the output port obtained by referring to the flow table 44.

At OP04, the input/output processing part 43 outputs the packet from the output port designated from the packet processing part 42. In this way, when the entry including the input port of the packet has been registered with the L port table 45 by referring to the L port table 45, the input/output processing part 43 does not inquire of the packet processing part 42 about the output port of the packet. The input/output processing part 43 outputs the packet from the output port associated with the input port in the L port table 45. That is, the reference to the flow table 44 (the process of the pack processing part 42) is cut-through.

In contrast, for a packet input from a port (a port of a normal path) other than the input port and the output port registered with the L port table 45, an output port is determined by referring to the flow table 44. The input/output processing part 43 outputs the packet from the determined (designated) output port.

In the example of FIG. 4, the input/output processing part 43 is connected to the ports 1 to 6 (P1 to P6), and a combination of the port 1 (P1) and the port 4 (P4) and a combination of the port 2 (P2) and the port 6 (P6) are used for packet transmission of the normal path. Therefore, these combinations pass through the process of the packet processing part 42 (the reference to the flow table 44). In contrast, a combination of the port 3 (P3) and the port 5 (P5) is a proprietary port (L port), the process of the packet processing part 42 is cut-through.

### Operation Example

Next, an operation example of the embodiment will be described. As an example, in a state where a normal path from the host 2 to the host 6 is set as illustrated in the FIG. 2A, an operation and process in a case where an L path is set, as illustrated in the FIG. 2B, according to an L path request, will be described.

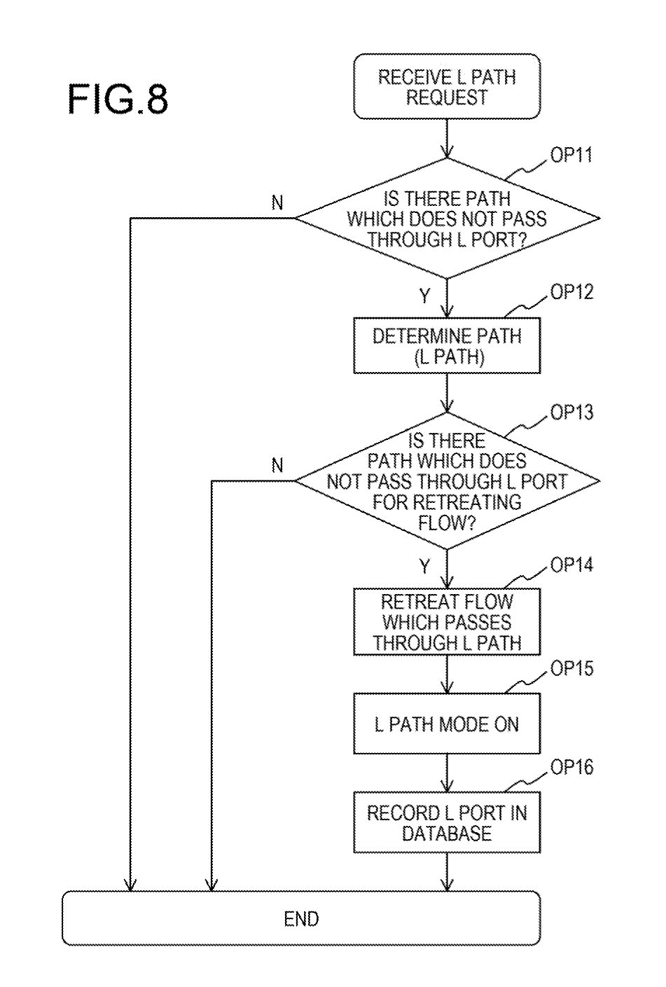

FIG. 8 is a flow chart illustrating an example of a process of the controller 1 when the L path is set. For example, the process of the FIG. 8 starts when the L path request reception part 38 receives an L path request. In this embodiment, a case where a new setting of the L path from the host 3 to the host 7 is requested will be described by way of an example.

At OP11, the flow scheduler 34 determines whether or not there is a route that does not pass through the L port. When it is determined that there is no route, the process of FIG. 8 is ended. In this case, no L path is set. When it is determined that there is a route, the process proceeds to OP12.

At OP11, the flow scheduler 34, by referring to the L port DB 37, checks whether there exists a route that does not pass through the L port. In the example of FIGS. 2A and 2B, no L port is registered with the L port DB 37 at this point of time. Therefore, the flow scheduler determines that there is a route that does not pass through the L port, and the process proceeds to OP12.

At OP12, the flow scheduler 34 determines the route of the L path by using the route processing part 39. For example, the flow scheduler 34 may determine a route as described with reference to FIGS. 2A and 2B, by referring to the NW DB 36. Alternatively, the flow scheduler 34 may determine the route of the L path by using a route of the existing normal path (host 2 host 6).

At OP13, the flow scheduler 34 determines whether or not there is a route that does not pass through an L port for retreating a flow of the normal path (a normal flow). The operation of OP13 is determined, for example, based on network configuration information stored in the NW DB 36 or retreat route information. In the example of FIGS. 2A and 2B, since a retreat route (bypass route) from the host 2 to the host 6 is found as illustrated in the FIG. 2B, a result of the determination of OP12 is Yes. When there is no retreat route, the process of FIG. 8 is ended without setting an L path.

At OP14, the flow scheduler 34 retreats the normal flow on the L path. That is, the flow scheduler 34 generates an OF message (FlowMod message) including a flow entry for transmitting a packet of the normal flow to the retreat route and transmits the generated OF message to a corresponding switch 2. The OF message is transmitted by the message transmission/reception part 33. In the example of FIGS. 2A and 2B, the OF message is transmitted to the switch A, the switch B, the switch E, the switch H, the switch F, the switch D, and the switch C on the retreat route.

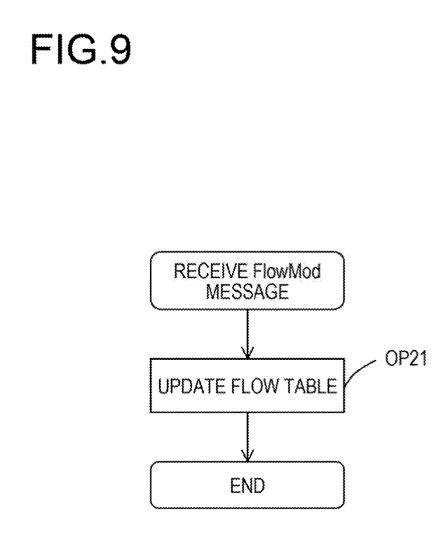

FIG. 9 is a flow chart illustrating an example of a process of the switch (OF-SW) 2 that has received the FlowMod message. The FlowMod message is received in the message transmission/reception part 41 and passed to the packet processing part 42.

The packet processing part 42 updates the flow table 44 based on the FlowMod message (OP21). For example, the packet processing part 42 of the switch A updates the flow entries of the flow table 44 according to an instruction in the FlowMod message such that a packet from the host 2 is output from the port 5, not the port 4.

In addition, the packet processing part 42 of the switch B adds a flow entry for outputting the packet of the host 2 from the port 4, to the flow table 44. In this way, the flow table 44 is updated in the switches 2 as well on the remaining retreat routes.

In addition, according to the update of the flow table of the switch 2, the flow table 35 of the controller 1 is also updated in the same way. In addition, as necessary, an OF message instructing a switch 2 (e.g., the switch G) deviated from a normal flow by retreat to delete a flow entry for the normal flow may be transmitted to the switch 2.

At OP15 of FIG. 8, an L path mode is set to ON. That is, the flow scheduler 34 generates an entry for the L port table 45 (called a second entry) for the switch 2 on the route of the L path. A message including the second entry (an L port setting message) is transmitted to the switch 2 on the L path. The L port setting message is transmitted by, for example, the message transmission/reception part 33.

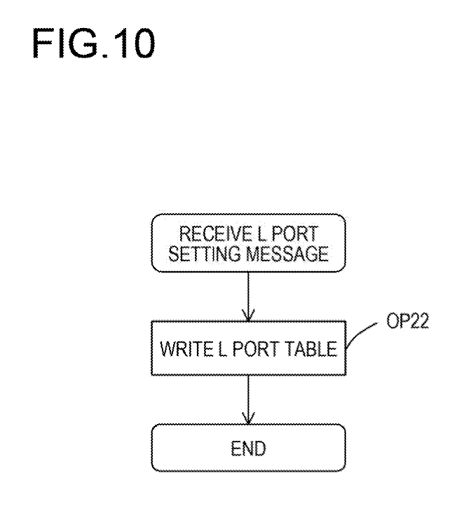

FIG. 10 is a flow chart illustrating an example of a process of the switch 2 that has received the L port setting message. For example, the L port setting message is received in the message transmission/reception part 41 and passed to the input/output processing part 43.

At OP22 of FIG. 10, the input/output processing part 43 writes (registers) the second entry of the L port setting message in the L port table 45. Thus, the input/output processing part 43 outputs the packet of the host 3, which is input from the input port designated in the second entry, from the output port designated in the second entry, thereby making the process of the packet processing part 42 to be in a cut-through state.

Referring back to FIG. 8, at OP16, the flow scheduler 34 records the L port in a database. That is, the flow scheduler 34 registers information of the L path with the L port DB 37. Thus, the contents as illustrated in FIG. 5 are registered with the L port DB 37. The information of the L path is used at the time of request for a new L path.

In addition, in the process of FIG. 8, in the operations of OP13 and OP14, flows other than the object flow are retreated to a retreat route according to the setting of the L path. However, there may be a case where the L path is set in a route where no existing flow is present. In this case, the operations of OP13 and OP14 may be omitted. Whether or not the existing flow is present may be determined, for example, by determining whether or not the route of the L path determined in OP12 overlays with a route of the existing flow stored in the NW DB 36.

Effects of Embodiment

In the above embodiment, the switch 2 (packet transmission apparatus) registers a flow entry (packet processing for the packet identification information) of a normal flow (the first flow), which is supplied from the controller 1 (control device), with the flow table 44 (the first table). In addition, the switch 2 registers the second entry, which indicates a correspondence relationship between an input port and an output port of a packet of a broadband flow (an object flow: the second flow different from the first flow), with the L port table 45 (the second table).

The input/output processing part 43 of the switch 2 outputs the packet of the object flow, which is received by an input port specified in the second entry, from an output port specified in the second entry. Thus, the reference to the flow table 44 is avoided (cut-through).

Due to the cut-through (avoidance) of the reference to the flow table 44, packet transmission time of the object flow in the switch 2 is shortened. In addition, the determination using the L port table 45 is a determination of whether or not an input port of a packet has been registered with the L port table 45, and does not refer to a parameter of the packet (header information of the packet). That is, the determination for the input port is a process simpler than matching between a match condition and a packet in the normal flow table. Therefore, a time taken to determine an output port using the L port table 45 may be shorter than a time taken to determine an output port using the flow table 44.

In addition, since flow entries for all normal paths are registered with the flow table 44, the number of entries may be large or enormous, thereby taking a long time to search a flow entry whose match condition matches a packet. In contrast, entries related to an L path less than the normal path are registered with the L port table 45. In this regard, a time required to determine an output port may be shortened.

Thus, the line speed of the L path may be made faster than the normal path. In addition, since the packet transmission time in the switch 2 may be shortened, it is possible to transmit packets of a broadband flow at a high speed. In addition, as frequent look-up (the process of the packet processing part 42) of the flow table 44 may be avoided, a load of the switch 2 may be reduced.

In addition, regarding the packets of the broadband flow, as a way to reduce the number of times of look-up of the flow table, the followings may be considered. For example, a way to refer to a flow table organizing a plurality of packets (which is called a “packet batching”) may be considered. Alternatively, another way to increase the size of a maximum transmission unit (MTU) of a packet (e.g., from 1,500 bytes to 9,000 bytes) may be considered. The way to avoid the reference of the flow table described in the above embodiment may make a packet staying time in the switch 2 shorter than the above-described way to reduce the number of times of look-up of the flow table.

In addition, when the L path is set, in a case where at least one of an input port and an output port exclusively used by an object flow is used for packet transmission of a flow other than the object flow, the packet processing part 42 performs the following operation. That is, the packet processing part 42 updates the flow table to transmit a flow other than the object flow to a retreat route.

That is, when at least one of an input port and an output port whose correspondence relationship is registered with the second table is being used by the flow other than the object flow, the packet processing part 42 performs the following operation. That is, the packet processing part 42 updates the first table such that a packet of the flow other than the object flow is transmitted using a port other than the input port and the output port.

In this way, as other flows are retreated to the retreat route, the proprietary state of the L port by a predetermined flow is secured. When the object flow exclusively uses the L port to exclude a process of a flow other than the object flow, the efficiency of packet processing for the object flow may be improved.

In addition, in this embodiment, in order for the controller 1 to unitarily manage a plurality of switches 2, the controller 1 generates and supplies flow entries and second entries for the switches 2. However, the flow entries and the second entries supplied for the switches 2 may be acquired in the switches 2 by means of communication with an apparatus other than the controller 1, read from a storage medium storing the flow entries and the second entries, etc. In addition, although the example where the second flow is a broadband flow has been described, a flow other than the broadband flow may be treated as the second flow.

Modification 1

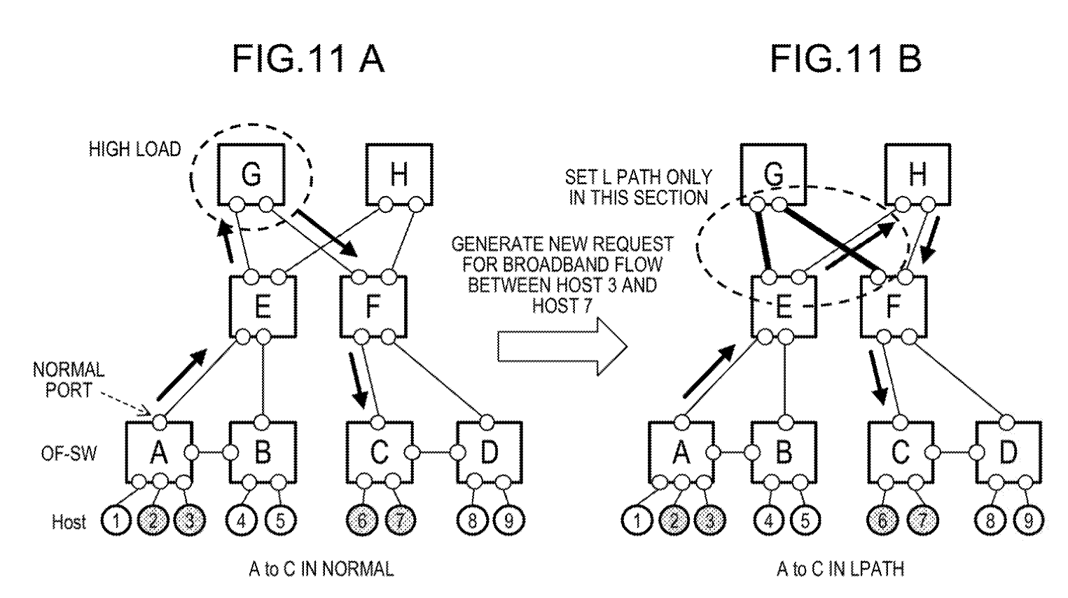

An example of setting all routes of the object flow between hosts as the L path has been described in the above embodiment. However, the L path may be set in some of the routes between hosts. For example, as illustrated in FIG. 11A, it is assumed that there exist a normal flow of a packet from the host 2 to the host 6 and a normal flow from the host 3 to the host 7 (see arrows in FIG. 11A). At this time, it is assumed that the switch G is in a high load state.

The switch 2 may send its own load situation to the controller 1 regularly or according to a request from the controller 1. Based on the load situation reported from the switch 2, the controller 1 determines whether or not the switch 2 is in a high load state. When it is determined that the switch 2 is in a high load state, the controller 1 performs the following process.

That is, for the flow from the host 3 to the host 7, the controller 1 sets a route between the port 1 of the switch G and the port 2 of the switch G as an L path (i.e., a path between the switch E and the switch G and between the switch G and the switch F as an L path).

At this time, in order to allow the path between the port 1 and the port 2 of the switch G to be exclusively occupied by the flow from the host 3 to the host 7, a route of the flow from the host 2 to the host 6 is changed to a retreat route going from the switch E to the switch H. As a result, a packet to be transmitted from the host 3 to the host 6 is avoided from passing through the switch G. Accordingly, a processing load of the switch G is reduced.

Such setting of a portion of the route as the L path may be performed by the process illustrated in FIGS. 8, 9 and 10. Specifically, in the operation of OP15 of FIG. 8, the setting is achieved when an L port setting message including the second entry is transmitted to the switch G which then registers the second entry with the L port table 45.

Modification 2

The controller 1 and the switch 2 of this embodiment may be modified as follows. For example, when the L path is a temporary path which continues for a predetermined time in response to a setting request of the L path, the L path may prevent a certain flow from exclusively occupying the ports of the switch 2 over a long time.

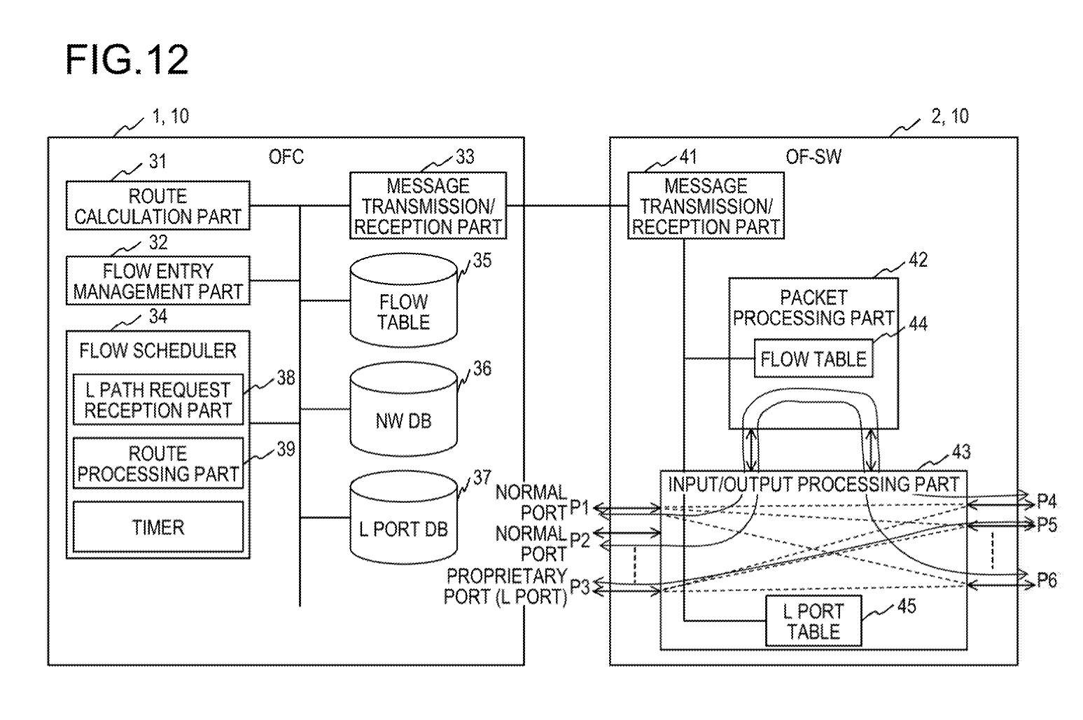

FIG. 12 illustrates an exemplary configuration of the controller 1 and the switch 2 according to Modification 2. The controller 1 illustrated in FIG. 12 is different from the controller 1 illustrated in FIG. 4 in that the flow scheduler 34 further includes a timer 51.

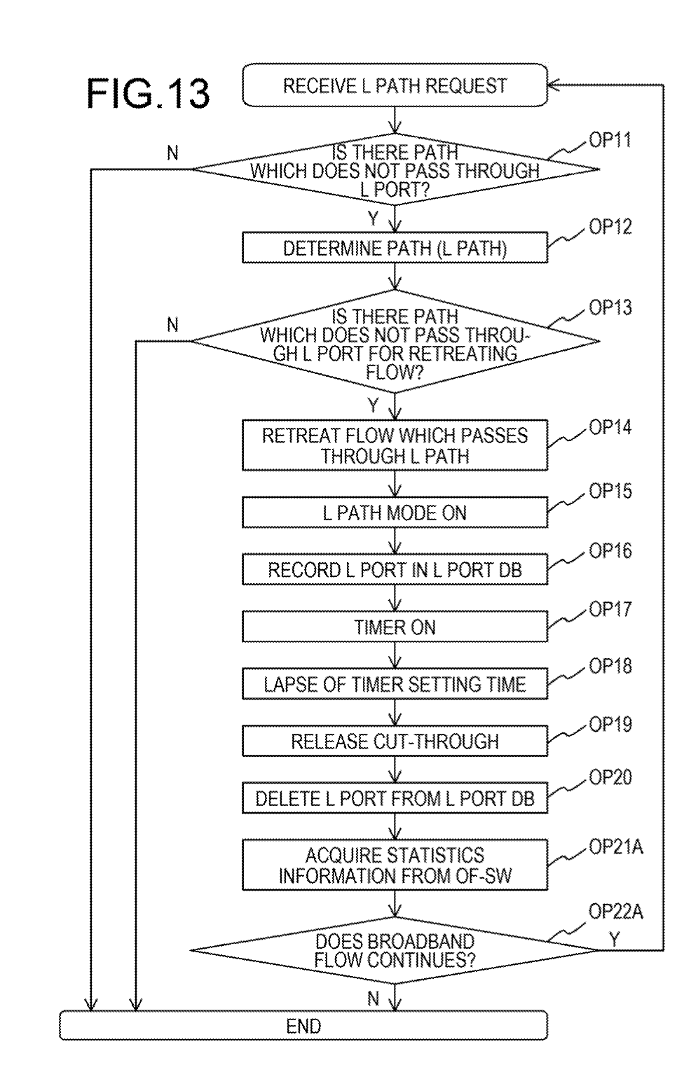

FIG. 13 is a flow chart illustrating an example of a process of the controller 1 in Modification 2. The operations from OP11 to OP16 are the same as those illustrated in FIG. 8 and, therefore, explanation of which will be omitted. At OP17, the flow scheduler 34 turns ON the timer 51 and starts counting for a predetermined period of time (timer setting time).

Upon detecting the expiration of the timer 51, i.e., the lapse of the timer setting time (OP18), the flow scheduler 34 performs a cut-through release process (OP19). That is, the flow scheduler 34 generates a message including an instruction to delete the second entry of the L port table 45. This message of the deletion instruction is transmitted to the switch 2 via the message transmission/reception part 33.

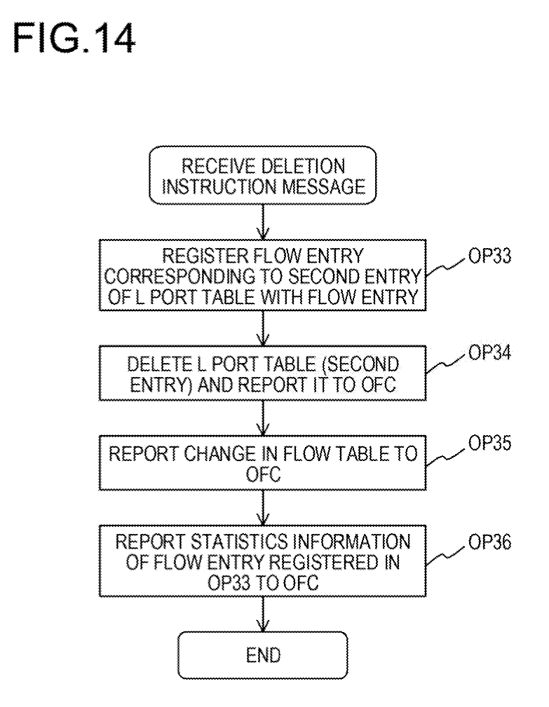

FIG. 14 is a flow chart illustrating an example of a process of the switch 2 that has received the deletion instruction message. At OP33, the input/output processing part 43 that has received the deletion instruction message generates a flow entry corresponding to the second entry. At this time, an “input port” in the second entry instructed to be deleted is set to a match condition of the flow entry. In addition, a “packet output to an output port” in the second entry instructed to be deleted is set to an action of the flow entry. The flow entry is given to the packet processing part 42 which then registers the flow entry with the flow table 44.

At OP34, the input/output processing part 43 deletes the second entry to be deleted, from the L port table 45. At this time, when the number of entries registered with the L port table 45 is zero, the L port table 45 may be deleted. In this case, the L port table 45 is created at the opportunity of setting of a new L path.

After deleting the second entry, the input/output processing part 43 transmits a message indicating the completion of deletion of the second entry to the controller 1. In addition, the packet processing part 42 sends an OF message (including an added flow entry) indicating a change in the flow table 44 to the controller 1 (OP35). The flow entry management part 32 of the controller 1 registers a flow entry included in the OF message with the flow table 35 and takes synchronization with the switch 2.

At OP36, the packet processing part 42 generates an OF message including a result of measurement of the number or quantity of packets transmitted using the flow entry added in the operation of OP33 (the number or quantity of packets of an object flow) periodically, for example, every time the unit time elapses. This OF message is transmitted to the controller 1 via the message transmission/reception part 41.

Referring back to FIG. 13, when the operation of OP19 is ended, at OP20, the flow scheduler 34 deletes information of the L port (information of the L path) related to the deletion instruction from the L port DB 37.

At OP21A in FIG. 13, the flow scheduler 34 acquires statistics information transmitted from the switch 2 in the operation of OP36 of FIG. 14. Then, at OP22A, the flow scheduler 34 determines whether or not the number or quantity of packets exceeds a predetermined threshold by referring to the statistics information. When it is determined that the number or quantity of packets exceeds the predetermined threshold, it is determined that the object flow (mass data transmission) continues. Meanwhile, when the number or quantity of packets is smaller than the predetermined threshold, it is determined that the object flow (mass data transmission) is ended.

When the number or quantity of packets exceeds the predetermined threshold, the flow scheduler 34 performs the same process as the case where the L path request is issued, that is, the process after OP11, to reestablish an L path for the route that deleted the second entry.

As described above, in Modification 2, the input/output processing part 43 performs the process of “deleting the correspondence relationship between the input port and the output port from the second table with the lapse of predetermined time.” In addition, the input/output processing part 43 performs a “process for registering action information indicating that a packet input to the input port is output from the output port, with the first table.” Further, the input/output processing part 43 performs a “process of transmitting the statistics information of the packet transmitted using the action information, to the control device.”

In the controller 1, the message transmission/reception part 33 “transmits the deletion instruction of the correspondence relationship from the second table.” In addition, the flow scheduler 34 (control part) “receives the statistics information of the packet output from the output port specified in the correspondence relationship, from the packet transmission apparatus which received the deletion instruction.” The flow scheduler 34 “controls the transmission of the correspondence relationship between the input port and the output port which is related to the object flow, based on the statistics information of the packet.”

Thus, in Modification 2, the controller 1 deletes the second entry and releases the cut-through at the opportunity of expiration of the timer 51, thereby allowing the input/output ports to be allocated to flows other than the object flow. Thereafter, when it is determined that packet transmission of the amount of data larger than a threshold is being performed on a route specified in the deleted second entry, it is possible to reestablish the L path to increase a communication speed in accordance with the mass data transmission (i.e., achieve a broadband for the object flow).

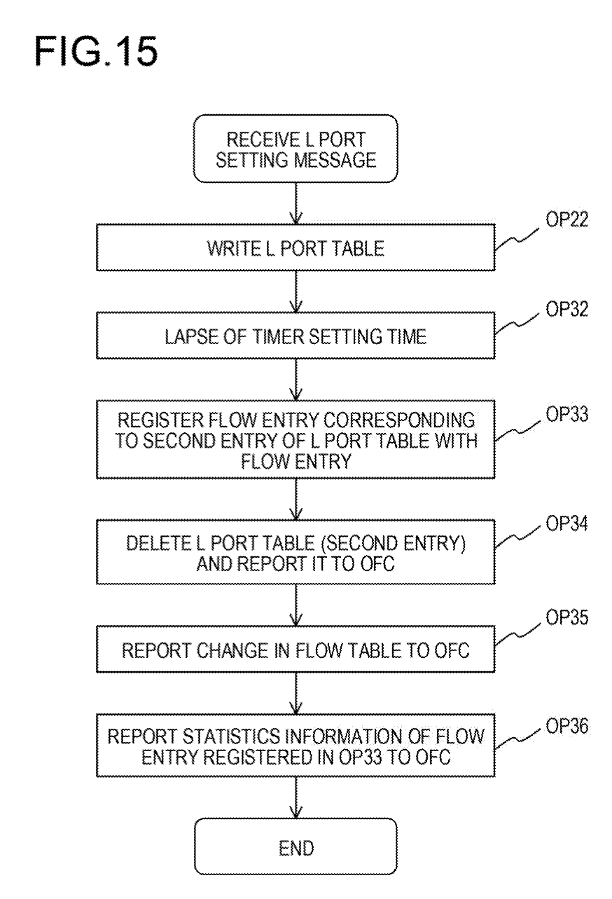

In addition, in Modification 2, the controller 1 counts the timer setting time and transmits the deletion instruction at the opportunity of expiration of the timer setting time. Instead of this configuration, as illustrated in FIG. 15, at the opportunity of registration of the second entry with the L port table 45 (OP22), the count of the timer setting time may be performed by the switch 2 (OP32 in FIG. 15) and a process after OP33 may be performed after the lapse of the timer setting time. In this case, the count of the timer 51 and the transmission of the deletion instruction message in the controller 1 may be omitted.

Modification 3

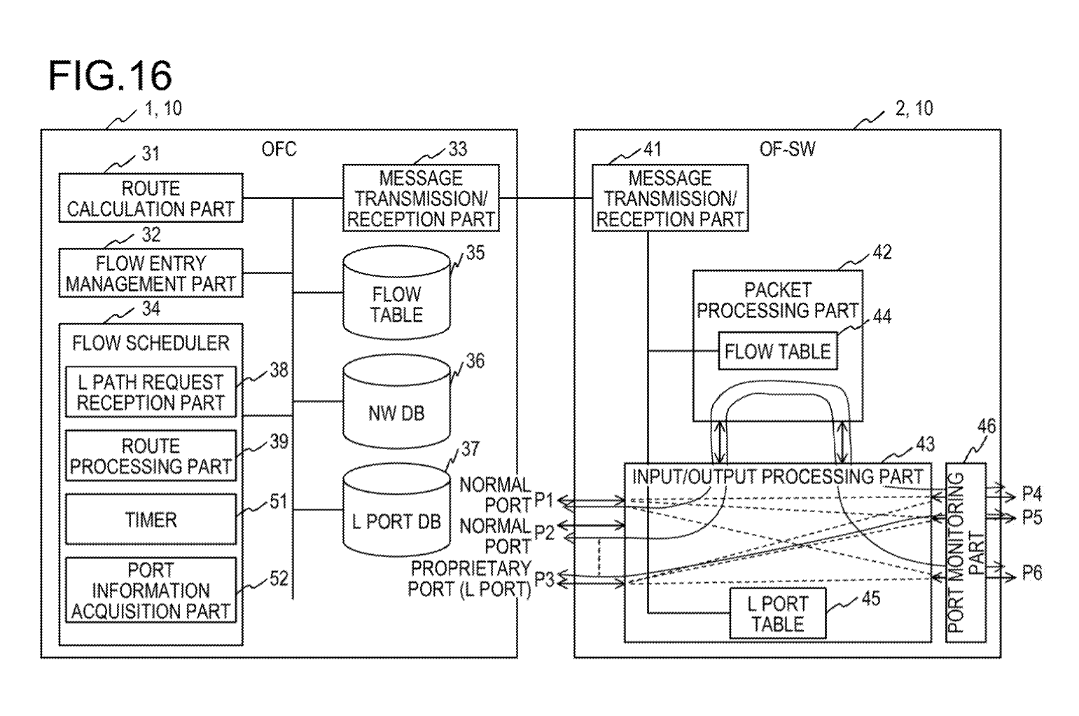

FIG. 16 illustrates an exemplary configuration of the controller 1 and the switch 2 according to Modification 3 of this embodiment. As illustrated in FIG. 16, the controller 1 according to Modification 3 is different from that of Modification 2 (FIG. 12) in that the flow scheduler 34 further includes a port information acquisition part 52. In addition, the switch 2 includes a port monitoring part 46 that monitors a port, measures the number or quantity of packets output from an output port, and sends a result of the measurement to the controller 1.

In Modification 3, the switch 2 transmits information indicating the transmission situation of packets using the correspondence relationship between the input port and the output port registered with the L port table 45, to the controller 1 (control device). In addition, the switch 2 performs a process of “deleting the correspondence relationship from the second table according to an instruction based on the transmission situation” from the controller 1.

In addition, in Modification 3, the flow scheduler 34 (control part) receives the transmission situation of packets using the correspondence relationship from each switch 2 (packet transmission apparatus) on a route of the object flow. Based on the transmission situation, the flow scheduler 34 supplies an instruction to delete the correspondence relationship from the L port table 45 (the second table), to each switch 2 (packet transmission apparatus) on the route of the object flow.

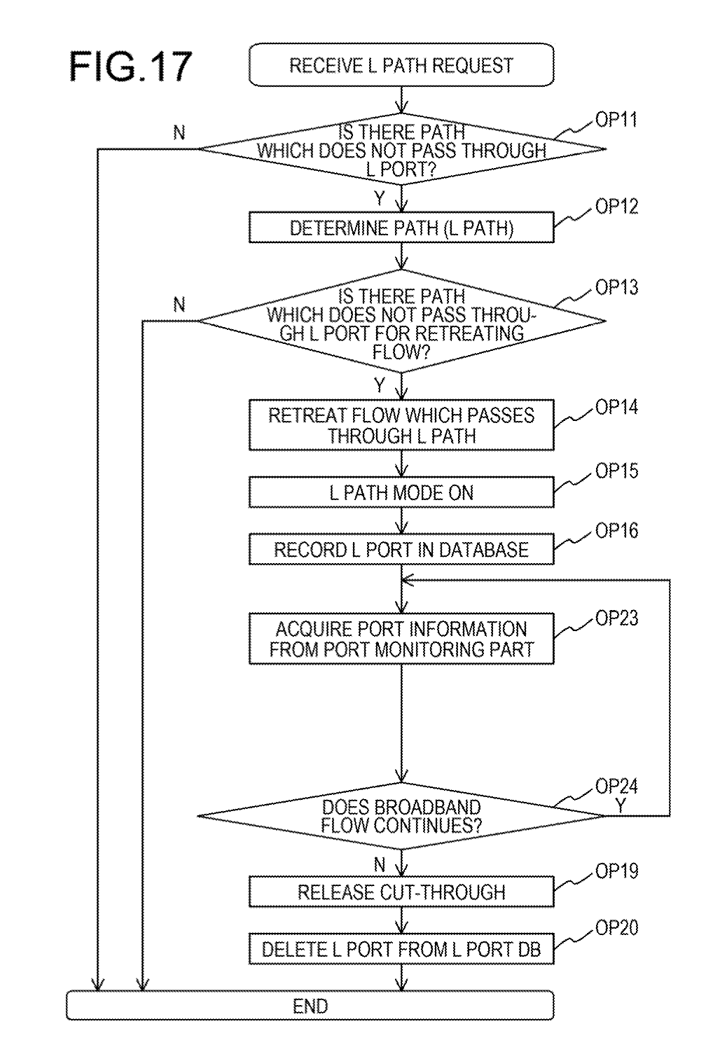

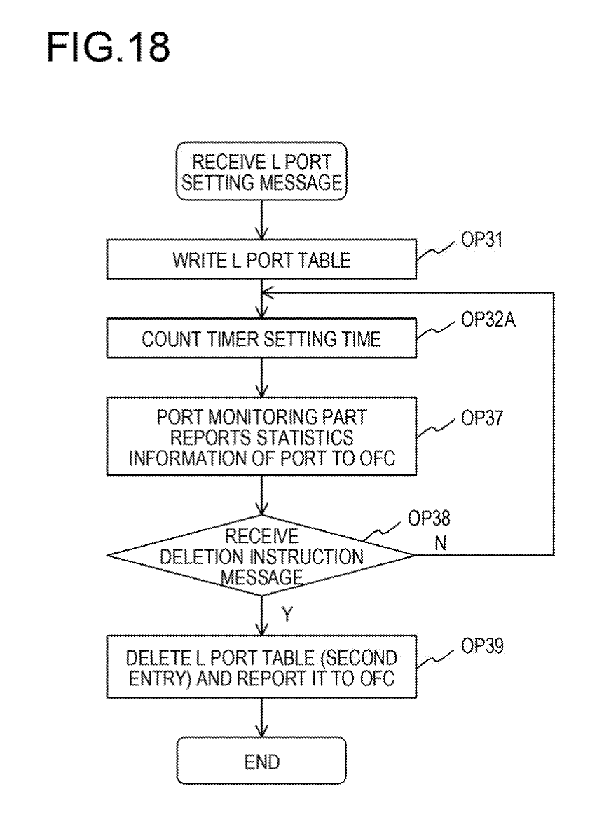

Specifically, in Modification 3, the following operation and process are performed. FIG. 17 illustrates an example of a process of the controller 1 in Modification 3. FIG. 18 is a flow chart illustrating an example of a process of the switch 2 in Modification 3. The operations of OP11 to OP16 in FIG. 17 are the same as those of the above embodiment (FIG. 18) and, therefore, explanation of which will be omitted.

Upon receiving an L port setting message and writing the second entry in the L port table 45, the switch 2 counts the timer setting time (OP32A). When the timer setting time elapses, the port monitoring part 46 transmits statistics information of a port (e.g., the number or quantity of packets per unit time output from the port) to the switch 2 (OP37).

The flow scheduler 34 of the controller 1 acquires the port statistics information from the port monitoring part 46 (OP23 in FIG. 17). The flow scheduler 34 determines whether or not the statistics information (the number or quantity of packets) exceeds a predetermined threshold (or is lowered to a predetermined range) (OP24 in FIG. 17).

When it is determined that the number or quantity of packets does not exceed the predetermined threshold (or is not lowered to the predetermined range), the flow scheduler 34 generates an instruction to delete the second entry and transmits the instruction to the corresponding switch 2 (OP19 in FIG. 17).

In the switch 2, upon receiving the deletion instruction (OP38 in FIG. 18), the input/output processing part 43 deletes the L port table 45 including the second entry and reports the completion of the deletion to the switch 2 (OP39 in FIG. 18).

When the deletion completion of the second entry is reported from the switch 2, the flow scheduler 34 deletes a corresponding entry from the L port DB 37 (OP20 in FIG. 17). Meanwhile, the count of the timer setting time in the switch 2 is performed regularly until the second entry is deleted.

In addition, in the process of FIGS. 17 and 18, the switch 2 counts the timer setting time. However, the controller 1 may count the timer setting time. In this case, when the timer setting time expires, the controller 1 may request the switch 2 to transmit the statistics information, and the port monitoring part 46 may transmit the statistics information according to the request.

In Modification 3, with the setting of the L port (the exclusive occupation of port by the object flow) maintained, it is determined whether or not the number or quantity of packets in the exclusively-occupied port has been lowered to the predetermined range every time the timer setting time elapses. The determination that the number or quantity of packets has been lowered to the predetermined range means the completion of the object flow. According to Modification 3, the exclusive occupation state of a port may be released by detecting the completion of the object flow and deleting the second entry from the L port table 45. In response to the deletion of the second entry, the same operations of OP33 to OP36 as the second embodiment may be performed. The configurations of the above-described embodiments may be used in proper combinations.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A packet transmission apparatus comprising:
a memory in which
identification information of a packet and information of a packet process for operating on the packet are stored in association, and
identifiers of an input port to which the packet is input and an output port from which the packet is output are stored in association; and
a processor coupled to the memory and the processor configured to:
output the packet, when an identifier of the input port is stored in the memory, from the output port associating with the input port, and
perform the packet process, when the identifier of the input port is not stored in the memory, based on the identification information and the information of the packet process stored in the memory.

2. The packet transmission apparatus according to claim 1,
wherein the processor is further configured to:
update the identification information and the information of the packet process stored in the memory so that a first flow to which the packet is transmitted by using the input port and the output port of the identifiers stored in the memory is transmitted by using a port other than the input port and the output port, when at least one of the input port and the output port of the identifiers stored in the memory is used by the first flow.

3. The packet transmission apparatus according to claim 1,
wherein identifiers of an input port and an output port allocated to a second flow requested for packet transmission in a broadband are stored in association in the memory.

4. The packet transmission apparatus according to claim 1,
wherein the processor is further configured to:
delete the identifiers of the input port and the output port from the memory with lapse of predetermined time,
store in the memory the information of packet process for outputting the packet input to the input port of an identifier deleted from the memory, from the output port of an identifier deleted from the memory, and
transmit statistics information of the packet transmitted by using the packet process, to a controller to control the packet transmission apparatus.

5. The packet transmission apparatus according to claim 1,
wherein the processor is further configured to:
transmit information for indicating a transmission situation of the packet using the input port and the output port of identifiers stored in association in the memory to a controller to control the packet transmission apparatus, and
delete the identifiers stored in association from the memory according to an instruction based on the information for indicating the transmission situation, the instruction being received from the controller.

6. A controller configured to control a packet transmission apparatus, the controller comprising:
a memory;
a processor coupled to the memory and the processor configured to:
transmit an instruction to store identification information of a packet of a first flow and information of a packet process for operating on the packet in the memory in association, to the packet transmission apparatus on a path of the first flow, and
transmit an instruction to store, in the memory, identifiers of an input port and an output port allocated to a second flow, to at least one packet transmission apparatus on the second flow.

7. The controller according to claim 6,
wherein the first flow is a flow to which the packet is transmitted by using the input port and the output port of the identifiers stored in the memory, and the second flow is a flow requested for packet transmission in a broadband.

8. The controller according to claim 6,
wherein the processor is further configured to:
transmit an instruction to store, in the memory, the information of packet process of transmitting the packet of the first flow using a port other than the input port and the output port of identifiers stored in association in the memory, when at least one of the input port and the output port of the identifiers stored in the memory is used by the first flow.

9. The controller according to claim 6,
wherein the processor is further configured to:
transmit an instruction to store the identifiers of the input port and the output port stored in association allocated to the second flow, to at least one packet transmission apparatus whose load exceeds a specific value, of a plurality of packet transmission apparatuses on a path of the second flow.

10. The controller according to claim 6,
wherein the processor is further configured to:
transmit an instruction to delete the identifiers of the input port and the output port stored in association from the memory,
receive statistics information of the packet output from the output port specified in the identifiers of the input port and the output port stored in association, and
transmit an instruction to store in the memory the identifiers of the input port and the output port related to the second flow based on the statistics information of the packet.

11. The controller according to claim 6,
wherein the processor is further configured to:
receive information for indicating a transmission situation of the packet using the input port and the output port of identifiers stored in association in the memory,
transmit an instruction to delete the identifiers of the input port and the output port stored in association from the memory, to the packet transmission apparatus on a path of the second flow, based on the information for indicating the transmission situation.

12. A packet transmission control method of a packet transmission system including a packet transmission apparatus and a controller to control the packet transmission apparatus, the packet transmission control method comprising:
transmit a first instruction to store identification information of a packet of a first flow and information of a packet process for operating on the packet in association, to the packet transmission apparatus on a path of the first flow, by the controller;
storing the identification information of the packet and the information of packet process for operating on the packet in association in a memory, based on the first instruction, by the packet transmission apparatus;
transmit a second instruction to store identifiers of an input port and an output port allocated to a second flow, to at least one packet transmission apparatus on the second flow, by the controller;
storing the identifiers of the input port and the output port in association in the memory, based on the second instruction, by the packet transmission apparatus;
outputting the packet, when an identifier of the input port to which the packet is input is stored in the memory, from the output port associating with the input port to which the packet is input, by the packet transmission apparatus, and
performing the packet process, when the identifier of the input port to which the packet is input is not stored in the memory, based on the identification information and the information of the packet process stored in the memory, by the packet transmission apparatus.
